(19) United States
(12) Patent Application Publication
(10) Pub. No.: US 2024/0111455 A1
(43) Pub. Date: Apr. 4, 2024

(54) Control Table Set Management In Storage Devices

(71) Applicant: Western Digital Technologies, Inc., San Jose, CA (US)

(72) Inventors: Nikita Thacker, Bangalore (IN); Ruthvick Suresh, Bangalore (IN)

(21) Appl. No.: 17/958,185

(22) Filed: Sep. 30, 2022

(51) Int. Cl. G06F 3/06

(52) U.S. Cl. CPC G06F 3/0659; G06F 3/0604; G06F 3/064; G06F 3/0683

(57) ABSTRACT

Various devices, such as storage devices or systems are configured to efficiently process and update logical maps within control table sets. Control table sets are often groupings of logical map corresponding to the logical locations of data requested by a host-computing device and the physical locations of the data within the memory array. As data is written and erased, these maps must be updated within the control table set. Received changes to these maps are typically stored and updated in two locations: a cache memory and a control table update list. By tracking and marking various control table sets as dirty or having undergone multiple changes, additional received updates can be stored and updated in only the cache memory, bypassing the second control table change list. By only utilizing one method of updating control table sets, processing overhead is reduced and various read or write activities are more efficiently done.

### FIELD

The present disclosure relates to storage systems. More particularly, the present disclosure relates to increasing data transfer speeds within a storage device by efficiently managing control table sets comprising logical to physical map data.

### BACKGROUND

Storage devices are ubiquitous within computing systems. Solid-state storage devices have become increasingly common. These nonvolatile storage devices can communicate and utilize various protocols including non-volatile memory express (NVMe), and peripheral component interconnect express (PCIe) to reduce processing overhead and increase efficiency.

Storage devices receive and process large numbers of requests from host-computing devices. The logical addresses requested by the host-computing device most often do not equate directly to the physical location of the data within the memory array of the storage device. Hence, most storage devices utilize logical to physical maps, or control tables, to write and retrieve data. These maps can be grouped together into control table sets and stored as fixed sizes of data to be accessed when required.

However, as data is moved around, added, or deleted from the storage device, the control table sets must also be updated. Often, a separate memory is utilized to store these updates (or “deltas”). This memory can operate as a control table change list that indicates what changes need to be performed on a particular control table set in order to make it up to date with the actual, current conditions.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a host-computing device with a storage system suitable for control table set management in accordance with an embodiment of the disclosure;

FIG. 2 is a schematic block diagram of a storage device suitable for control table set management in accordance with an embodiment of the disclosure;

FIG. 3A is conceptual illustration of a control table set in accordance with an embodiment of the disclosure;

FIG. 3B is a conceptual illustration of a control table set divided into a subset of control table sets in accordance with an embodiment of the disclosure;

FIG. 3C is a conceptual illustration of a control table set in accordance with an embodiment of the disclosure;

FIG. 3D is a conceptual illustration of a subset of control table set with the initial block and an additional block in accordance with an embodiment of the disclosure;

FIG. 3E is a conceptual illustration of a plurality of subsets of control table set in accordance with an embodiment of the disclosure;

FIG. 3F is a conceptual illustration of a plurality of subsets of control table set in accordance with an embodiment of the disclosure;

FIG. 4 is a flowchart depicting a process for managing control table sets in accordance with an embodiment of the disclosure;

FIG. 5 is a flowchart depicting a process for managing control table sets using a map function in accordance with an embodiment of the disclosure; and

FIG. 6 is a flowchart depicting a process for searching for one or more occurrences of an entry in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

With the ever-increasing capacities of storage devices and the required random performance for the latest generation of storage devices, the number of control table data entries needs to be increased to be able to store more updates occurred as a result of spike in number of read and/or write operations. As a direct result of such a spike in read and/or write operations, performing the search operation has become increasingly time-consuming. To tackle this issue, various embodiments of the disclosure divide the control table set into subsets of control table sets.

Additionally, in a variety of embodiments, the control table set can be divided into subsets of control table sets with each subset of control table set storing entries for a particular range of logical to physical address map updates, and instead of having nodes between every entry, there can be nodes between arrays of fixed size. In such embodiments, upon receiving a data entry indicating logical to physical address map updates, the subset of control table sets to which the entry belongs is determined. If the subset of control table set has vacancy, then the entry is stored, otherwise, an additional block is allocated to the subset of control table sets and the entry is stored in the additional block. By utilizing subsets of control table sets which are designated to store a certain range of entries, the time to perform the search operation to find an entry can be significantly decreased. Moreover, by only allocating additional blocks to the subsets of control table sets that store frequent updates, the storage can be saved as the size of the less frequently updated subsets of control table sets remains intact.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

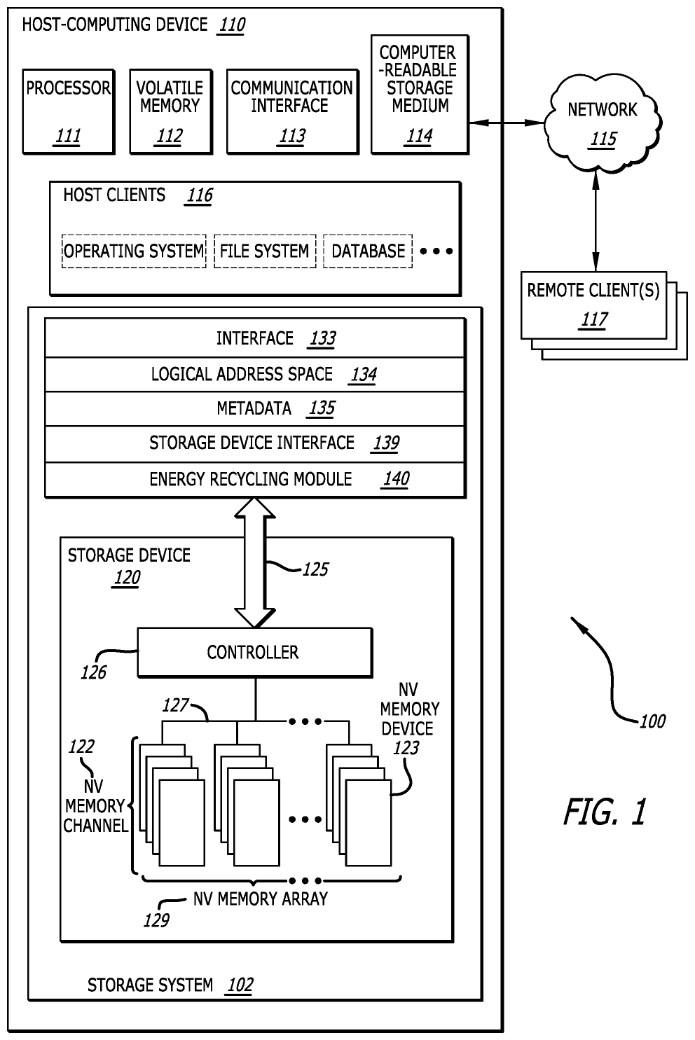

Referring to FIG. 1, a schematic block diagram of a host-computing device 110 with a storage system suitable for control table set management in accordance with an embodiment of the disclosure is shown. The control table set management system 100 may comprise one or more storage devices 120 of a storage system 102 within a host-computing device 110 in communication via a controller 126. The host-computing device 110 may include a processor 111, volatile memory 112, and a communication interface 113. The processor 111 may include one or more central processing units, one or more general-purpose processors, one or more application-specific processors, one or more virtual processors (e.g., the host-computing device 110 may be a virtual machine operating within a host), one or more processor cores, or the like. The communication interface 113 may include one or more network interfaces configured to communicatively couple the host-computing device 110 and/or controller 126 of the storage device 120 to a communication network 115, such as an Internet Protocol (IP) network, a Storage Area Network (SAN), wireless network, wired network, or the like.

The storage device 120, in various embodiments, may be disposed in one or more different locations relative to the host-computing device 110. In one embodiment, the storage device 120 comprises one or more non-volatile memory devices 123, such as semiconductor chips or packages or other integrated circuit devices disposed on one or more printed circuit boards, storage housings, and/or other mechanical and/or electrical support structures. For example, the storage device 120 may comprise one or more direct inline memory module (DEVIM) cards, one or more expansion cards and/or daughter cards, a solid-state-drive (SSD) or other hard drive device, and/or may have another memory and/or storage form factor. The storage device 120 may be integrated with and/or mounted on a motherboard of the host-computing device 110, installed in a port and/or slot of the host-computing device 110, installed on a different host-computing device 110 and/or a dedicated storage appliance on the network 115, in communication with the host-computing device 110 over an external bus (e.g., an external hard drive), or the like.

The storage device 120, in one embodiment, may be disposed on a memory bus of a processor 111 (e.g., on the same memory bus as the volatile memory 112, on a different memory bus from the volatile memory 112, in place of the volatile memory 112, or the like). In a further embodiment, the storage device 120 may be disposed on a peripheral bus of the host-computing device 110, such as a peripheral component interconnect express (PCI Express or PCIe) bus such, as but not limited to a NVM Express (NVMe) interface, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCIe Advanced Switching (PCIe-AS) bus, or the like. In another embodiment, the storage device 120 may be disposed on a communication network 115, such as an Ethernet network, an Infiniband network, SCSI RDMA over a network 115, a storage area network (SAN), a local area network (LAN), a wide area network (WAN) such as the Internet, another wired and/or wireless network 115, or the like.

The host-computing device 110 may further comprise computer-readable storage medium 114. The computer-readable storage medium 114 may comprise executable instructions configured to cause the host-computing device 110 (e.g., processor 111) to perform steps of one or more of the methods disclosed herein.

A device driver and/or the controller 126, in certain embodiments, may present a logical address space 134 to the host clients 116. As used herein, a logical address space 134 refers to a logical representation of memory resources. The logical address space 134 may comprise a plurality (e.g., range) of logical addresses (logical to physical address map data). As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

A device driver for the storage device 120 may maintain metadata 135, such as a logical to physical address map structure, to map logical addresses of the logical address space 134 to media storage locations on the storage device(s) 120. A device driver may be configured to provide storage services to one or more host clients 116. The host clients 116 may include local clients operating on the host-computing device 110 and/or remote clients 117 accessible via the network 115 and/or communication interface 113. The host clients 116 may include, but are not limited to: operating systems, file systems, database applications, server applications, kernel-level processes, user-level processes, applications, and the like.

In many embodiments, the host-computing device 110 can include a plurality of virtual machines which may be instantiated or otherwise created based on user-request. As will be understood by those skilled in the art, a host-computing device 110 may create a plurality of virtual machines configured as virtual hosts which is limited only on the available computing resources and/or demand. A hypervisor can be available to create, run, and otherwise manage the plurality of virtual machines. Each virtual machine may include a plurality of virtual host clients similar to host clients 116 that may utilize the storage system 102 to store and access data.

The device driver may be further communicatively coupled to one or more storage systems 102 which may include different types and configurations of storage devices 120 including, but not limited to: solid-state storage devices, semiconductor storage devices, SAN storage resources, or the like. The one or more storage devices 120 may comprise one or more respective controllers 126 and non-volatile memory channels 122. The device driver may provide access to the one or more storage devices 120 via any compatible protocols or interface 133 such as, but not limited to, SATA and PCIe. The metadata 135 may be used to manage and/or track data operations performed through the protocols or interfaces 133. The logical address space 134 may comprise a plurality of logical addresses, each corresponding to respective media locations of the one or more storage devices 120. The device driver may maintain metadata 135 comprising any-to-any maps between logical addresses and media locations.

A device driver may further comprise and/or be in communication with a storage device interface 139 configured to transfer data, commands, and/or queries to the one or more storage devices 120 over a bus 125, which may include, but is not limited to: a memory bus of a processor 111, a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network 115, Infiniband, SCSI RDMA, or the like. The storage device interface 139 may communicate with the one or more storage devices 120 using input-output control (IO-CTL) command(s), IO-CTL command extension(s), remote direct memory access, or the like.

The communication interface 113 may comprise one or more network interfaces configured to communicatively couple the host-computing device 110 and/or the controller 126 to a network 115 and/or to one or more remote clients 117 (which can act as another host). The controller 126 is part of and/or in communication with one or more storage devices 120. Although FIG. 1 depicts a single storage device 120, the disclosure is not limited in this regard and could be adapted to incorporate any number of storage devices 120.

The storage device 120 may comprise one or more non-volatile memory devices 123 of non-volatile memory channels 122, which may include but is not limited to: ReRAM, Memristor memory, programmable metallization cell memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon Oxide-Nitride-Oxide-Silicon (SONOS), programmable metallization cell (PMC), conductive-bridging RAM (CBRAM), magneto-resistive RAM (MRAM), magnetic storage media (e.g., hard disk, tape), optical storage media, or the like. The one or more non-volatile memory devices 123 of the non-volatile memory channels 122, in certain embodiments, comprise storage class memory (SCM) (e.g., write in place memory, or the like).

While the non-volatile memory channels 122 is referred to herein as “memory media,” in various embodiments, the non-volatile memory channels 122 may more generally comprise one or more non-volatile recording media capable of recording data, which may be referred to as a non-volatile memory medium, a non-volatile memory device, or the like. Further, the storage device 120, in various embodiments, may comprise a non-volatile recording device, a non-volatile memory array 129, a plurality of interconnected storage devices in an array, or the like.

The non-volatile memory channels 122 may comprise one or more non-volatile memory devices 123, which may include, but are not limited to: chips, packages, planes, die, or the like. A controller 126 may be configured to manage data operations on the non-volatile memory channels 122, and may comprise one or more processors, programmable processors (e.g., FPGAs), ASICs, micro-controllers, or the like. In some embodiments, the controller 126 is configured to store data on and/or read data from the non-volatile memory channels 122, to transfer data to/from the storage device 120, and so on.

The controller 126 may be communicatively coupled to the non-volatile memory channels 122 by way of a bus 127. The bus 127 may comprise an I/O bus for communicating data to/from the non-volatile memory devices 123. The bus 127 may further comprise a control bus for communicating addressing and other command and control information to the non-volatile memory devices 123. In some embodiments, the bus 127 may communicatively couple the non-volatile memory devices 123 to the controller 126 in parallel. This parallel access may allow the non-volatile memory devices 123 to be managed as a group, forming a non-volatile memory array 129. The non-volatile memory devices 123 may be partitioned into respective logical memory units (e.g., logical pages) and/or logical memory divisions (e.g., logical blocks). The logical memory units may be formed by logically combining physical memory units of each of the non-volatile memory devices 123.

The controller 126 may organize a block of word lines within a non-volatile memory device 123, in certain embodiments, using addresses of the word lines, such that the word lines are logically organized into a monotonically increasing sequence (e.g., decoding and/or translating addresses for word lines into a monotonically increasing sequence, or the like). In a further embodiment, word lines of a block within a non-volatile memory device 123 may be physically arranged in a monotonically increasing sequence of word line addresses, with consecutively addressed word lines also being physically adjacent (e.g., WL0, WL1, WL2, . . . WLN).

The controller 126 may comprise and/or be in communication with a device driver executing on the host-computing device 110. A device driver may provide storage services to the host clients 116 via one or more interfaces 133. A device driver may further comprise a storage device interface 139 that is configured to transfer data, commands, and/or queries to the controller 126 over a bus 125, as described above.

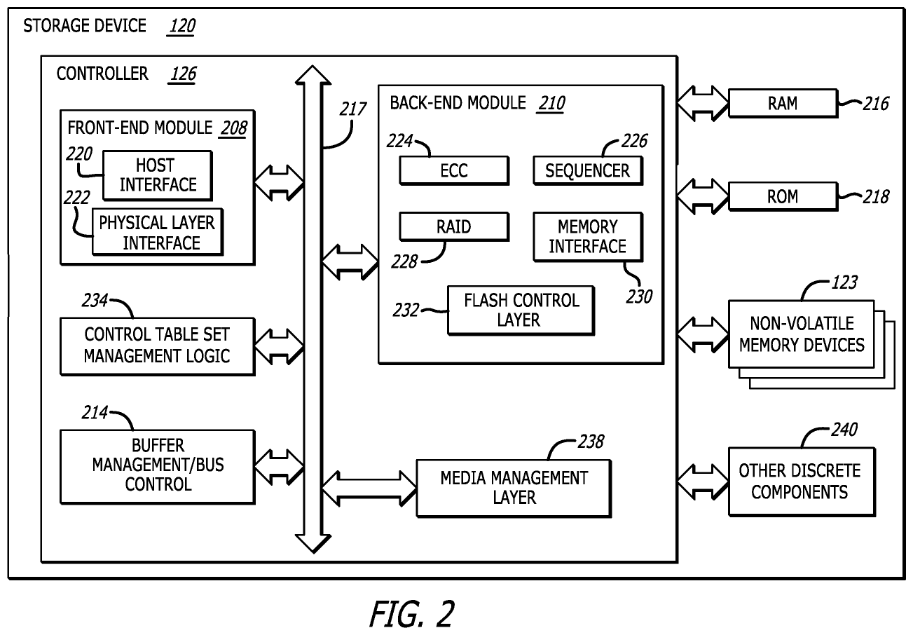

The storage system 102 may also include an energy recycling module 140. In various embodiments, the energy recycling module 140 may be disposed within a storage system, such as the embodiment depicted in FIG. 1. However, it is contemplated that many embodiments comprise at least one energy recycling module 140 disposed within the storage device 120 itself. As described in further detail below, the energy recycling module can be configured to capture excess heat and generate electricity that can be stored or utilized to power other components within the storage device 120 and/or storage system 102. The energy recycling module 140 may also be configured to operate in a cooling mode that can receive a power supply and cool one or more surfaces of various components within the storage device 120 or storage system 102. It should also be noted that the energy recycling module 140 may be similar to the energy recycling modules discussed throughout this disclosure such as those described in FIGS. 2-6.

Referring to FIG. 2, a schematic block diagram of a storage device 120 suitable for control table set management in accordance with an embodiment of the disclosure is shown. The controller 126 may include a front-end module 208 that interfaces with a host via a plurality of communication channels, a back-end module 210 that interfaces with the non-volatile memory devices 123, and various other modules that perform various functions of the storage device 120. In some examples, each module may just be the portion of the memory that comprises instructions executable with the processor to implement the features of the corresponding module without the module including any other hardware. Because each module includes at least some hardware even when the included hardware comprises software, each module may be interchangeably referred to as a hardware module.

The controller 126 may include a buffer management/bus control module 214 that manages buffers in random access memory (RAM) 216 and controls the internal bus arbitration for communication on an internal communications bus 217 of the controller 126. A read only memory (ROM) 218 may store and/or access system boot code. Although illustrated in FIG. 2 as located separately from the controller 126, in other embodiments one or both of the RAM 216 and the ROM 218 may be located within the controller 126. In yet other embodiments, portions of RAM 216 and ROM 218 may be located both within the controller 126 and outside the controller 126. Further, in some implementations, the controller 126, the RAM 216, and the ROM 218 may be located on separate semiconductor dies. As discussed below, in one implementation, the submission queues and the completion queues may be stored in a controller memory buffer, which may be housed in RAM 216.

Additionally, the front-end module 208 may include a host interface 220 and a physical layer interface 222 that provides the electrical interface with the host or next level storage controller. The choice of the type of the host interface 220 can depend on the type of memory being used. Examples types of the host interfaces 220 may include, but are not limited to, SATA, SATA Express, SAS, Fibre Channel, USB, PCIe, and NVMe. The host interface 220 may typically facilitate transfer for data, control signals, and timing signals.

The back-end module 210 may include an error correction controller (ECC) engine 224 that encodes the data bytes received from the host and decodes and error corrects the data bytes read from the non-volatile memory devices 123. The back-end module 210 may also include a command sequencer 226 that generates command sequences, such as program, read, and erase command sequences, to be transmitted to the non-volatile memory devices 123. Additionally, the back-end module 210 may include a RAID (Redundant Array of Independent Drives) module 228 that manages generation of RAID parity and recovery of failed data. The RAID parity may be used as an additional level of integrity protection for the data being written into the storage device 120. In some cases, the RAID module 228 may be a part of the ECC engine 224. A memory interface 230 provides the command sequences to the non-volatile memory devices 123 and receives status information from the non-volatile memory devices 123. Along with the command sequences and status information, data to be programmed into and read from the non-volatile memory devices 123 may be communicated through the memory interface 230. A flash control layer 232 may control the overall operation of back-end module 210.

Additional modules of the storage device 120 illustrated in FIG. 2 may include a media management layer 238, which performs wear leveling of memory cells of the non-volatile memory devices 123. The storage device 120 may also include other discrete components 240, such as energy recycling modules, external electrical interfaces, external RAM, resistors, capacitors, or other components that may interface with controller 126. In alternative embodiments, one or more of the RAID modules 228, media management layer 238 and buffer management/bus control module 214 are optional components that may not be necessary in the controller 126.

Finally, the controller 126 may also comprise a control table set management logic 234. In many embodiments, the control table set management logic 234 can be configured to monitor the state of control table sets within the storage device 120. For example, the control table set management logic 234 may configure and operate the control table cache and/or the control table change lists. The control table set management logic 234 can direct which control table sets should be transferred into and out of the control table cache. Likewise, the control table change lists can be allocated, managed, and deleted by the control table set management logic 234.

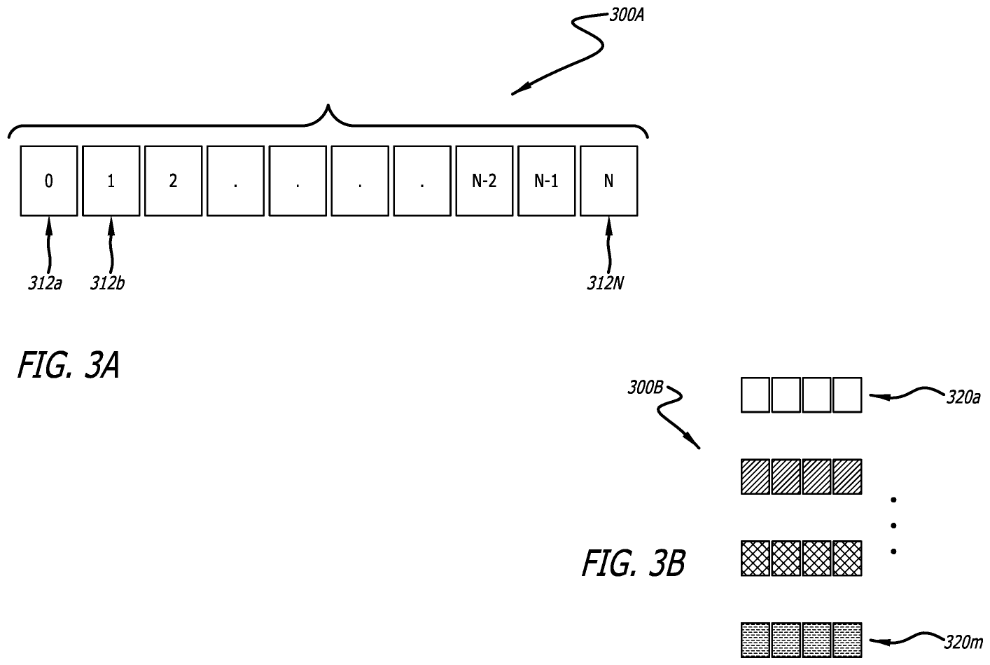

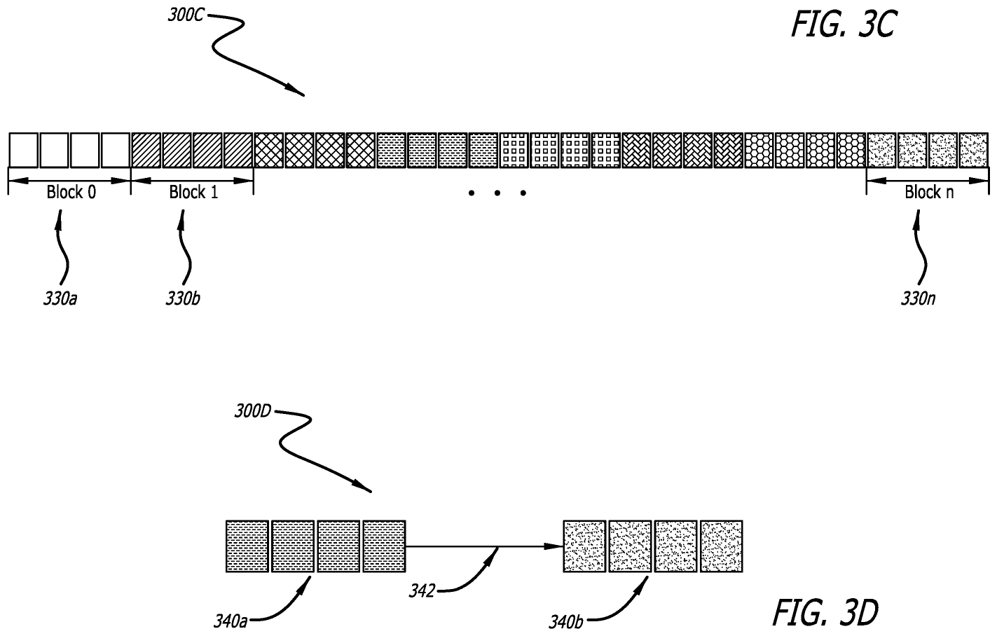

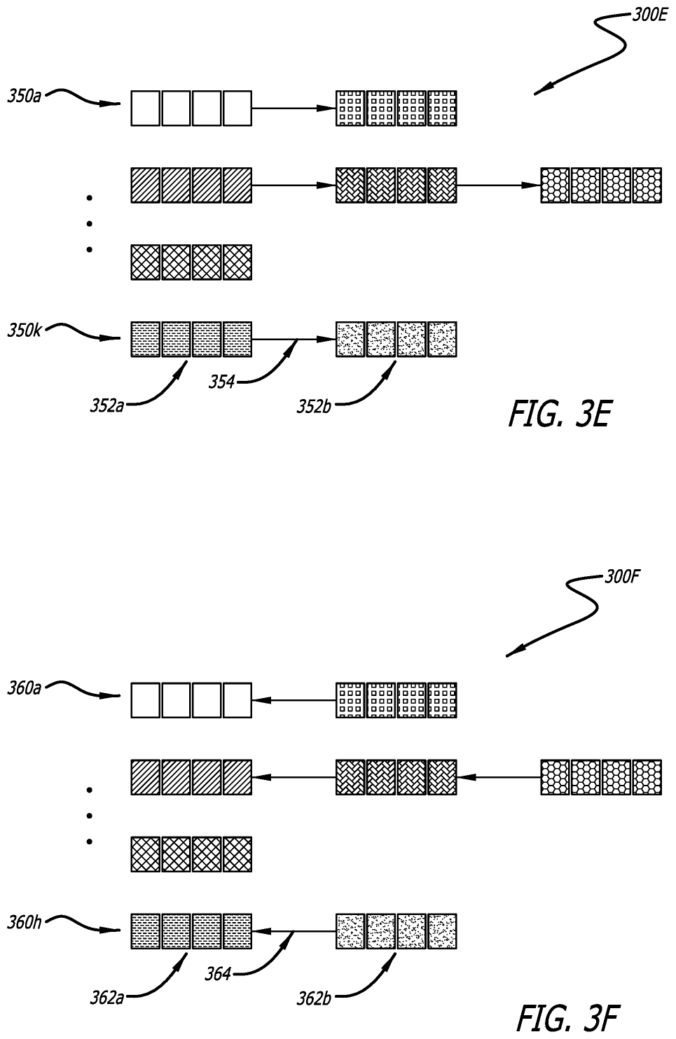

Referring to FIG. 3A, a conceptual illustration of a control table set 300A in accordance with an embodiment of the disclosure is shown. Typically, a control table set 300A can include a set of control table data entries 312a, 312b, . . . , 312N. Each control table data entry 312a, 312b, . . . , 312N can store a particular set of logical to physical address map updates. In the control table set 300A shown in FIG. 3A, the control table set 300A includes N+1 control table data entries 0-N. Upon receiving a new set of logical to physical address map updates (hereinafter “entry”) a new control data table entry can be added to the end of the control table set 300A, at which the new entry can be stored. Once a search command is received from the host computer, e.g., a read or write command, the control table set 300A can be searched, i.e., scanned, from the first end, i.e., control table data entry 312a, to the last end, i.e., control table data set 213N. While, the search operation can be performed sequentially, a person skilled in the art will understand that a binary search operation can also be performed to find the desired entry. In an embodiment, even if the desired entry is found, the search operation can continue to the last end to find the most recent occurrence of the desired entry. Thus, the time taken to perform the entire search operation is of the order of 0 (N). As a non-limiting example, in an embodiment, the size of the control table set 300A can be 20k bytes and the size of each entry can be 16 bytes. In such an embodiment, the control table set 300A can include 1280 control table data entries 312a, 312b, . . . 312N. That is, N can be 1280.

In order to decrease the time required to perform the search operation, various embodiments of the disclosure divide the control table set of size N into m subsets of control table sets, in which m≤N. Each of the subsets of control table sets can include at least one block to store the entries. Dividing the control table set into subsets of control table sets is described in more details in the following sections.

Referring to FIG. 3B, a conceptual illustration of a control table set 300B divided into a subset of control table sets in accordance with an embodiment of the disclosure is shown. In an embodiment, the control table set 300B can be divided into m subset of control table sets 320a, . . . , 320m. In the conceptual control table set shown in FIG. 3B, the control table set 300B is divided into 4 subsets of control table sets, i.e., m=4. However, a person skilled in the art will understand that the number of subsets of control table sets, m, can be any integer less than the total number of control table data entries (N as shown in FIG. 3A). That is, 0<m<N. In various embodiments, each subset of the subsets of control table sets, i.e., each of 320a, . . . , 320m, can include a same number of control table data entry. For example, in an embodiment, each subset of the subsets of control table sets, i.e., each of 320a, . . . , 320m, can include 4 control table data entries. However, it should be noted that, each subset of the subsets of control table sets, i.e., each of 320a, . . . , 320m, can include a different number of control table data entries. In various embodiments, the range of entries that each of the subset of control table sets 320a, . . . , 320m can include is fixed. In an embodiment, a map function can be used to map each control table data entry to a particular subset of control table sets. The map function can be a mathematical function. In an embodiment, the map function can split the control table data entries so that each of the subsets of control table sets can store a fixed number of control table data entries. In previous example, each subset of control table sets can store 25% of the control table data entries. That is, the first control subset of table sets can store the first 25% of the control table data entries, i.e., control table data entries 0%-25%, the second control subset of table sets can store the second 25% of the control table data entries, i.e., control table data entries 26%-50%, the third control subset of table sets can store the third 25% of the control table data entries, i.e., control table data entries 51%-75%, and the fourth control subset of table sets can store the fourth 25% of the control table data entries, i.e., control table data entries 76%-100%.

In an embodiment, if there are more frequent updates in a particular subset of control table set compared to other subset of control table sets, then the particular subset of control table set may become full and unable to store additional updates, while other subsets of control table sets have available space for more updates. Thus, the size of each of the subsets of control table sets should be increased, which in turn would lead to an unnecessary increase in the size of the overall control table set and cause the search operation to become more time-consuming.

In an embodiment, the subsets of control table sets can be linked via a linked list, i.e., a pointer. Each subset of control table sets can have a head node and a new node can be allocated from the common pool and attached to the subset of control table sets whenever needed. In an embodiment, the subset of control table sets with a total size of N can be divided into k (k<<N) subsets of control table sets with each subset of control table set storing entries for a particular range of logical to physical address map updates, and instead of having nodes between every entry, there can be nodes between arrays of size x, so that the maximum time required for searching any entry reduces from N to k and extra space require for maintaining dynamic allocation of nodes is reduced by a factor of x. In various embodiments, value of x can be configured statically or dynamically depending on use case.

Referring to FIG. 3C, a conceptual illustration of a control table set 300C in accordance with an embodiment of the disclosure is shown. In an embodiment, the control table set 300C can include a set of blocks 330a, 330b, . . . , 330n. Each block 330a, 330b, . . . , 330n, can include a same number of control table data entry. However, it should be noted that, each block i.e., each of 330a, 330b, . . . , 330n, can include a different number of control table data entries. In various embodiments, each block 330a, 330b, . . . , 330n can store a particular set of logical to physical address map updates. Initially, each of the subset of control table sets includes one block 330a, 330b, . . . , 330n which can hold x entries.

Referring to FIG. 3D now, a conceptual illustration of a subset of control table set 300D with the initial block and an additional block in accordance with an embodiment of the disclosure is shown. In an embodiment, the subset of control table sets 300D can include the initial block 340a. Once the initial block 340a of a subset of control table set 300D is full, i.e., no longer has available position to store a new entry, a new block 340b can be allocated to the subset of control table sets 300D. The additional allocated block 340b can be added to the end of the full block 340a and be linked to the full block 340a via a pointer 342. As a non-limiting example, when the control table set is divided into 4 subsets of control table sets, i.e., k=4, and each subset of control table sets is configured to include an initial block to store 100 entries, then the initial block, and hence the subset of control table set, will be full when the initial block has 100 entries. After the initial block is full with 100 entries in it, the new block is allocated to the subset of control table set which is linked to the initial block by a pointer.

Referring to FIG. 3E, a conceptual illustration of a plurality of subsets of control table set 300E in accordance with an embodiment of the disclosure are shown. In an embodiment, the control table set can be divided into k subsets of control table sets 350a, . . . , 350k. Each subset of control table set 350, . . . , 350k can initially include one block. Once the initial block is full, an additional block is allocated to the subset of control table set. As shown in FIG. 3E, while the initial blocks of at least two of the subsets of control table sets are full and an additional block is allocated to each subset of control table sets, for one of the subsets of control table sets, both the initial block and the first additional block are full and a second additional block is allocated to the subset of control table sets. As an example, the subset of control table set 350k includes an initial block 352a and an additional block 352b, linked together via a pointer 354.

In various embodiments, the time taken to perform search operation to find an entry in the control table set of size N can be reduced to N/k. Disclosed block allocation method can facilitate avoiding the condition of unavailability of space in the control table sets, while using minimal extra space, i.e., reducing the extra space by a factor of x. In some embodiments, at least one of k and x can be dynamically configurable. In some embodiments, if further improvement in time is required, then value of k can be increased. Additionally, if using extra space is a constraint, then value of x can be increased. In an embodiment, a number of entries in the control table set and a number of the subsets of control table sets ca be determined and used to calculate a size of each block.

Referring to FIG. 3F, a conceptual illustration of a plurality of subsets of control table set 300F in accordance with an embodiment of the disclosure are shown. In an embodiment, in order to find the latest occurrence of an entry, the subset of control table sets can be searched from the beginning till the last entry even though first occurrence of the entry is found earlier in the subset of control table sets. Since typically the latest occurrence of the entry is needed, in some embodiments, the search operation can start from the end of the latest block of the subset of control table sets and move towards to the beginning of the subset of control table sets. As an example, the search operation can be performed in each of the subsets of control table sets 360a, . . . , 360h from the last block towards the initial block. As an example, the search operation is performed on the subset of control table sets 360h starting from the last block 362b and towards the first block 362a. The first block 362a and the last block 362b are linked together via the pointer 364.

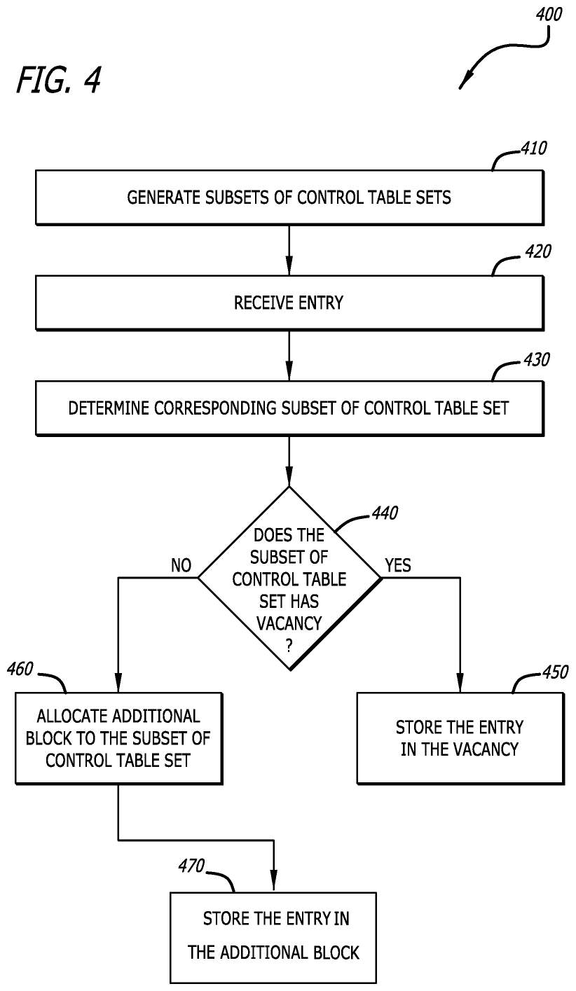

Referring to FIG. 4 now, a flowchart depicting a process 400 for managing control table sets in accordance with an embodiment of the disclosure is shown. In many embodiments, the process 400 can generate subsets of control table sets, as shown by block 410. In an embodiment, once the subsets of control table sets are generated, the process 400 can receive an entry, as shown in block 420. Each entry can be an update for a logical to physical address map.

In some embodiments, the process 400 can determine a corresponding subset of control table set, to which the entry belongs, as shown by block 430. In various embodiments, the process 400 can then determine whether the subset of control table sets that the entry belongs to is full or has vacancy, as shown by block 440. If the subset of control table sets that the entry belongs to has vacancy, the process 400 can store the entry in the subset of control table sets, as shown by block 450. Alternatively upon a determination that the subset of control table sets that the entry belongs to has no vacancy, i.e., is full, then the process 400 can allocate an additional block to the subset of control table sets and link the additional block and the full block via a pointer, as shown by block 460. In some embodiments, the process 400 then store the entry in the allocated additional block, as shown by block 470.

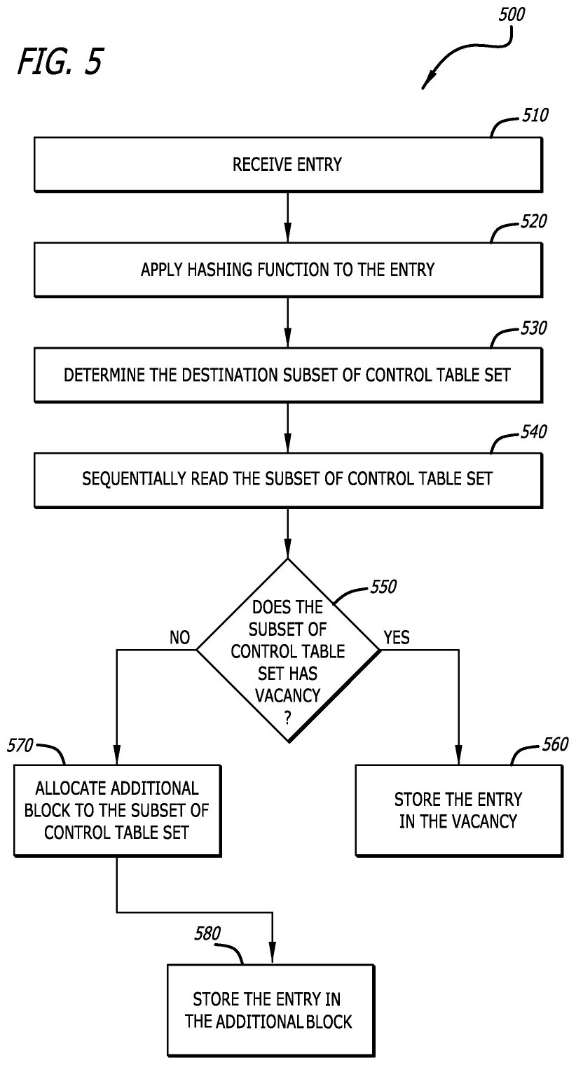

Referring to FIG. 5 now, a flowchart depicting a process 500 for managing control table sets using a map function in accordance with an embodiment of the disclosure is shown. The process 500 can receive an entry as shown by block 510. Each entry can be an update for a logical to physical address map. In some embodiments, the process 500 can apply a map function, e.g., a hashing function, to the entry, as shown by block 520. The map function can be used to map each entry to a particular subset of control table sets, and can be a mathematical function.

In some embodiments, the process 500 can determine a destination subset of control table sets for the entry based on the applied map function as shown by block 530. In various embodiments, the process 500 can then perform a sequential search on the subset of control table sets, as shown by block 540. In various embodiments, the process 500 can determine whether the destination subset of control table sets is full or has vacancy, as shown by block 550. Upon a determination that the destination subset of control table sets has vacancy, the process 500 can store the entry in the vacancy of destination subset of control table sets, as shown by block 560. Alternatively if the destination subset of control table sets is full, then the process 500 can allocate an additional block to the subset of control table sets as shown by block 570. The process 500 can further store the entry in the allocated additional block, as shown block 580.

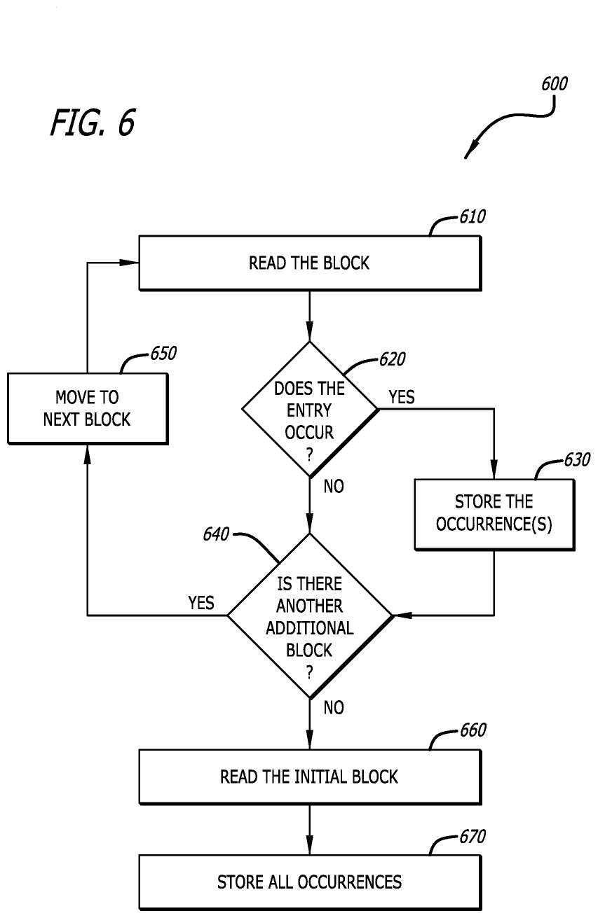

Referring to FIG. 6, a flowchart depicting a process 600 for searching for one or more occurrences of an entry in accordance with an embodiment of the disclosure is shown. The process 600 can read a block, as shown by block 610. The block can be the last block that is stored in the control table sets. In other words, the process 600 can perform a read operation sequentially from the last block. In an embodiment, the process 600 can determine whether or not the entry is found, i.e., whether or not the update occurred, in the block, as shown by block 620. In an embodiment, the entry may not occur. Additionally, in an embodiment, the entry can occur more than once. If the update occurred, the process 600 can store the occurrence(s), as shown by block 630. In several embodiments, if the process 600 determines that the entry did not occur in the block, the process 600 can determine whether or not there is any additional block left, as shown by block 640. If there is/are any additional block(s) left, then the process 600 can move to the next bock, as shown by block 650. In some embodiments, upon a determination that no additional block is left unread, i.e., all the additional blocks are searched, the process 600 can read the initial block, as shown by block 660. The process 600 can then store all occurrences of the entry, as shown by block 670.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, including:
a processor;
a memory array comprising a plurality of memory devices, wherein the plurality of memory devices include a plurality of control table sets; and
a control table set management logic configured to:
generate one or more subsets of control table sets by dividing the plurality of control table sets, wherein each of the one or more subsets of control table sets include at least one block configured to store a set of data entries;
upon receiving a data entry, determine a subset of control table sets of the generated one or more subsets of control table sets associated with the data entry;
store the data entry in the determined subset of control table sets; and
upon a determination that the at least one block has no vacant position to store the data entry, allocate an additional block to the determined subset of control table sets.

2. The device of claim 1, wherein to store the data entry in the determined subset of control table sets, the control table set management logic is configured to:
perform a first read operation on the determined subset of control table sets sequentially to identify the vacant position to store the data entry; and
store the data entry in the vacant position of the determined subset of control table sets.

3. The device of claim 1, wherein the at least one block and the additional block have a same size.

4. The device of claim 1, wherein the control table set logic is configured to apply a hashing function to the data entry to determine the subset of control table sets associated with the data entry.

5. The device of claim 1, wherein each of the plurality of control table sets is configured to store logical-to-physical map data entries.

6. The device of claim 1, wherein each of the one or more subsets of control table sets is configured to store a distinct range of logical-to-physical address map data entries.

7. The device of claim 1, wherein the control table set logic is configured to:
determine a number of data entries in the plurality of control table sets;
determine a number of the one or more subsets of control table sets; and
calculate a size of each of the at least one block based on the determined number of data entries in the plurality of control table sets and the determined number of the one or more subsets of control table sets.

8. The device of claim 1, wherein the control table set logic is configured to:
perform a second read operation on the at least one block and the additional block of the one or more subsets of control table sets, wherein the second read operation is performed from a last block towards a first block of the one or more subsets of control table sets; and
identify a last occurrence of each data entry in the one or more subsets of control table sets.

9. The device of claim 8, wherein the second read operation is performed sequentially.

10. The device of claim 8, wherein the control table set logic is configured to determine all occurrences of each data entry in the one or more subsets of control table sets.

11. The device of claim 1, wherein each of the one or more subsets of control table sets is initially configured with one block.

12. A method for managing control table sets, the method comprising:
generating one or more subsets of control table sets by dividing the plurality of control table sets, wherein each of the one or more subsets of control table sets includes at least one block configured to store a set of data entries;
upon receiving a data entry, determining a subset of control table sets of the generated one or more subsets of control table sets associated with the data entry;
storing the data entry in the determined subset of control table sets; and
upon a determination that the at least one block has no vacant position to store the data entry, allocating an additional block to the determined subset of control table sets.

13. The method of claim 12, wherein storing the data entry in the determined subset of control table sets comprises:
performing a first read operation on the determined subset of control table sets sequentially to identify the vacant position to store the data entry; and
storing the data entry in the vacant position of the determined subset of control table sets.

14. The method of claim 12, further comprising applying a hashing function to the data entry to determine the subset of control table sets associated with the data entry.

15. The method of claim 12, further comprising:
determining a number of data entries in the plurality of control table sets;
determining a number of the one or more subsets of control table sets; and
calculating a size of each of the at least one block based on the determined number of data entries in the plurality of control table sets and the determined number of the one or more subsets of control table sets.

16. The method of claim 12, further comprising:
performing a second read operation on the at least one block and the additional block of the one or more subsets of control table sets, wherein the second read operation is performed from a last block towards a first block of the one or more subsets of control table sets; and
identifying a last occurrence of each data entry in the one or more subsets of control table sets.

17. The method of claim 16, wherein the second reading operation is performed sequentially.

18. The method of claim 16, further comprising determining all occurrences of each data entry in the one or more subsets of control table sets.

19. The method of claim 12, wherein each of the one or more subsets of control table sets is configured to store a distinct range of logical-to-physical address map data entries.

20. A storage device, comprising:
a processor;
a memory array communicatively coupled to the processor, the memory array comprising a plurality of memory devices, wherein the plurality of memory devices include a plurality of control table sets; and
a control table set management logic configured to:
generate one or more subsets of control table sets based on the plurality of control table sets, wherein each of the one or more subsets of control table sets has a same size;
assign a range of data entries to each of the generated one or more subsets of control table sets, wherein each of the range of data entries of each of the generated one or more subsets of control table sets is distinct from other range of data entries of other generated subsets of control table sets; and
in response to receiving a data entry, store the data entry in a corresponding subset of control table set.
